(19) United States
(12) Patent Application Publication
(10) Pub. No.: US 2013/0266127 A1
(43) Pub. Date: Oct. 10, 2013

(54) SYSTEM AND METHOD FOR REMOVING SENSITIVE DATA FROM A RECORDING

(71) Applicants: Jeffrey Schachter, Littleton, MA (US); Keith David Levin, Jamaica Plain, MA (US)

(72) Inventors: Jeffrey Schachter, Littleton, MA (US); Keith David Levin, Jamaica Plain, MA (US)

(73) Assignee: Raytheon BBN Technologies Corp, Cambridge, MA (US)

(21) Appl. No.: 13/443,726

(22) Filed: Apr. 10, 2012

(51) Int. Cl. H04M 1/64

(52) U.S. Cl. 379/88.01

(57) ABSTRACT

Systems and methods for, among other things, removing sensitive data from an recording. The method, in certain embodiments, includes receiving an audio recording of a call and a text transcription of the audio recording, identifying events which occur during the call by detecting characteristic audio patterns in the audio recording and selected keywords and phrases in the text transcription, determining, from the identified events, a first event which precedes sensitive data in the call and a second event which occurs after sensitive data in the call, determining a portion of the call containing sensitive data with a start time at the first event and an end time at the second event, and removing the portion of the call between the start time and end time from the audio recording.

### FIELD OF THE INVENTION

The systems and methods described herein relate to the management of call recordings, and in particular, to systems and methods for removing sensitive data such as financial or personal information from call recordings.

### BACKGROUND

Today, businesses create, record or otherwise produce substantial amounts of sound or video recording. Often, these recordings are generated by recording live, unscripted interactions between individuals, such as between a customer and a call center attendant, a call-in-guest and a radio talk show host, or a surgeon and a team of assisting nurses working in a surgery theater. The recorded data creates a record which can be stored for later use, such as to create closed caption for a television show, or for creating a transcript to record instructions given during surgery.

Probably the most common example of live recording occurs at call centers that record calls to record customer and agent interactions. These recordings may be used to determine the quality of service the call center provided. The effectiveness or performance of a call center agent may be determined by analyzing a database of audio recordings of calls for metrics such as the number of customers served, the number of dropped calls, or the average time of a call.

However, audio recordings of calls or a live broadcast may also contain sensitive information such as caller financial or private information. For example, when placing an order through a call center, a caller may input his or her credit card number, either by pressing the corresponding numbers on a telephone keypad or by speaking the digits. Alternatively, a recording of a surgery may include patient data, such as name and medical history. In some instances, it may be undesirable, or even unlawful, to record this sensitive information. Unencrypted audio recordings with sensitive data may be accessed at a later date by an unauthorized party, creating the possibility for identity theft, privacy violation and credit card fraud. In fact, the Payment Card Industry Data Security Standard (PCI DSS) prohibits call centers from storing recordings which contain a caller's card verification value (CVV). The Health Insurance Portability and Accountability (HIPPA) restricts use of patient data to assure that an individual's health information is properly protected, and not improperly disclosed. Thus, call centers need systems which can either remove sensitive information from audio recordings or prevent the sensitive information from being recorded in the first place.

Current call center systems of the prior art solve the aforementioned problem in various ways. For example, some systems allow an operative to manually turn the audio recording off when a party is inputting sensitive information. However, such systems add complexity and rely on individual behavior to prevent the recording of sensitive information, which may be unreliable, inconsistent, and introduce human error. Other systems allow an operator to listen to the recorded data and delete the sensitive information. For short recordings, this has worked well but for a longer recording or large numbers of recordings, these manual systems are too labor intensive. Therefore, there exists a need in the art for an automated, fully configurable system for removing sensitive data from audio recordings.

### SUMMARY OF THE INVENTION

The systems and methods described herein relate to, among other things, removing sensitive data from a recording which is typically audio, but may be an audio and video recording as well. Sensitive data may be any information which a user wishes to remove from the recording, such as credit card numbers, card verification values (CVV), account numbers, social security numbers, medical data, military information, profanity, caller financial information, or other private information. In one embodiment, the systems and method described herein receive a recording, whether audio, video or both. The system identifies within the recording events that are characteristic patterns, typically audio patterns but they may be video patterns or a combination of audio and video patterns. To identify the events, the system may compare patterns found in the recording with patterns stored in a database of known patterns. The system may then select from the identified events a location within the recording that includes, or is likely to include, sensitive data. In one embodiment, the system identifies the location of the sensitive data by applying a finite state machine that receives the identified events as inputs, which are applied to the state machine in the order the events appear within the recording. The finite state machine may transition through states, driven by the sequence of events, and may be driven into a state that indicates the presence, and the location, within the recording of sensitive data. From this state, the system identifies a time segment within the recording to process and thereby may remove the sensitive data from the recording.

In one particular embodiment, the system and methods described herein include systems that receive an end-to-end audio recording of a call and analyze the call to detect events and actions that occur during the call, such as spoken keywords, phrases, IVR prompts, or user inputs. The system may allow a user to fully configure which events are detected during the call, effectively defining what type of sensitive information to remove from the call. After configuration, the system may automatically identify and remove portions of the audio recording which contain the sensitive information. Embodiments of the systems and methods described herein may be added to an existing call center system, or may be provided by a separate call diagnostics center as a value added service. In this way, the systems and methods described herein provide an automated, fully configurable algorithm for removing sensitive data from audio recordings of calls which may be easily integrated into existing call center systems.

More particularly, these methods receive an audio recording of a call, identify events representative of characteristic audio patterns which occur during the call by comparing the audio recording to a database of known, or predetermined audio patterns, determine from the identified events, a portion of the call containing sensitive data, wherein the portion of the call is a time segment having a start time and end time, and removing the portion of the call between the start time and end time from the audio recording. Optionally, the methods may further comprise receiving a text transcription of the audio recording and identifying events representative of speech by comparing the text transcription to a determined list of keywords, phrases and patterns.

In some embodiments, the audio recording may include an IVR portion, a queue portion, and one or more agent/caller conversations. The IVR portion may initially present the user with a menu containing a series of options, which the user may select by either pressing a corresponding number on a telephone keypad or by speaking the option. In response, the IVR system may present further options as will be apparent to those skilled in the art. If the IVR system fails to address the caller's concern, the caller may then be transferred to a human agent. The queue portion of the call occurs when a human agent is not immediately available and the caller is placed “on hold.” The queue portion may comprise a period of silence, music, or any other audio recording that is presented to the caller while he or she waits.

The systems and methods may analyze the end-to-end recording, including the IVR, queue, and agent/caller dialogues, to detect events which occur during the call. These events may include characteristic audio patterns occurring in the call which have been previously identified in a predetermined list as indicative of sensitive information. For example, the IVR prompt which presents the user with a series of options, as well as the DTMF inputs by the user, may be detected and recorded as events. Other characteristic audio patterns include, among others, a period of silence, a change in volume, a change in speaker, or music. All of these may be modeled or otherwise stored as known or predetermined audio patterns that can be matched to tones, sounds or other features in the recording. In some embodiments, a speech-to-text transcription may be received or generated along with the audio recording, and certain keywords or phrases may also be detected as events. For example, the words “credit card” spoken by an agent and detected in the text transcription may indicate that the caller is about to enter credit card information. Finally, the systems and methods may allow a user to manually define an event which does not fall into one of the aforementioned categories.

The events as detected above may be passed to a finite state model which defines states for different portions of the call. In general, a call state can be any information which describes the context of the call, for example whether the caller is in the IVR, queue, or agent dialogue portion of the call. For the purposes of removing sensitive information, the finite state model may define portions of the call which either contain sensitive information, immediately precede sensitive information, or which do not contain sensitive information. The portions of the call with sensitive information are removed from the audio recording, typically by replacing the portion of the call with nondescript audio, such as a flat tone, white noise, or silence. In addition to being removed from the audio recording, the sensitive portion may also be removed from the text transcript by deleting or overwriting the sensitive text.

In some embodiments, the audio recording may include multiple audio channels for each participant of the call. Such a recording may be generated by recording the incoming audio and the outbound audio on separate audio channels. For example, a stereo recording may include the caller audio on the left channel and the IVR/agent audio on the right channel. This may advantageously allow the channels to be analyzed and redacted separately. An event which is detected in one channel of the recording, such as the agent saying “Please input your credit card number” may precede sensitive information in the second channel, such as the caller speaking a series of credit card digits. Thus, the sensitive information may be redacted from only the caller audio, leaving the agent prompts intact.

Other objects, features, and advantages of the present invention will become apparent upon examining the following detailed description, taken in conjunction with the attached drawings.

### BRIEF DESCRIPTION OF CERTAIN ILLUSTRATED EMBODIMENTS

The systems and methods described herein are set forth in the appended claims. However, for purpose of explanation, several illustrative embodiments are set forth in the following figures.

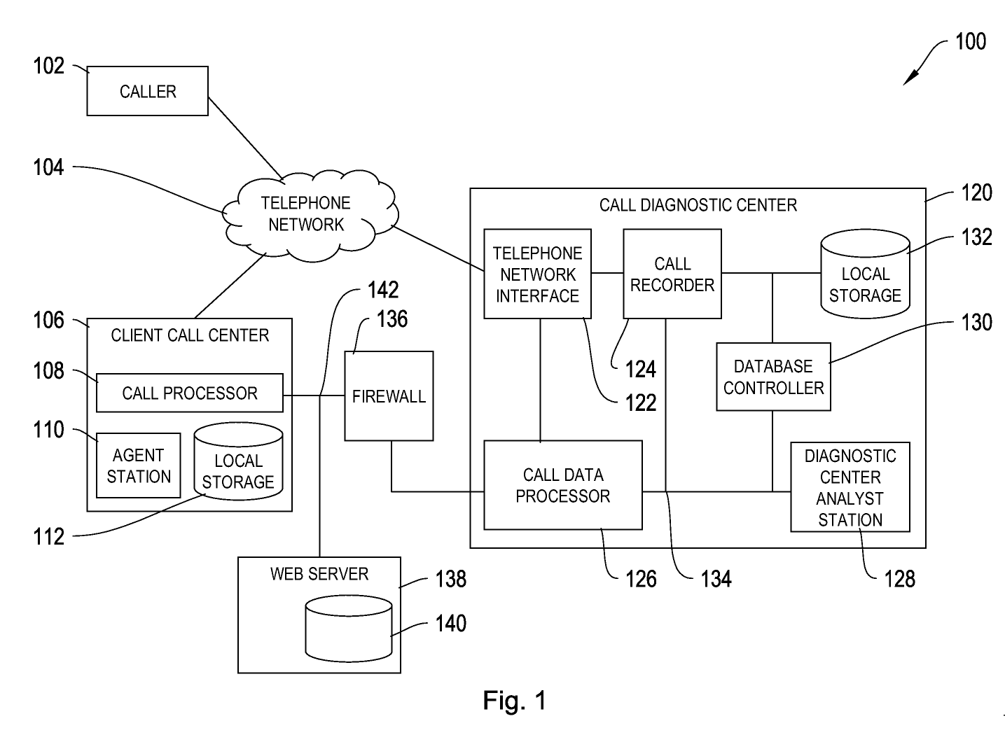

FIG. 1 depicts an illustrative system for removing sensitive information from a call recording in which some embodiments may operate.

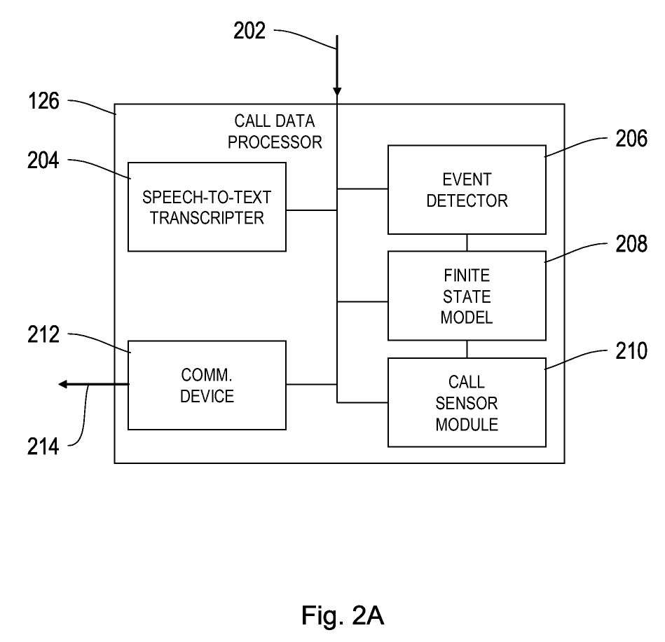

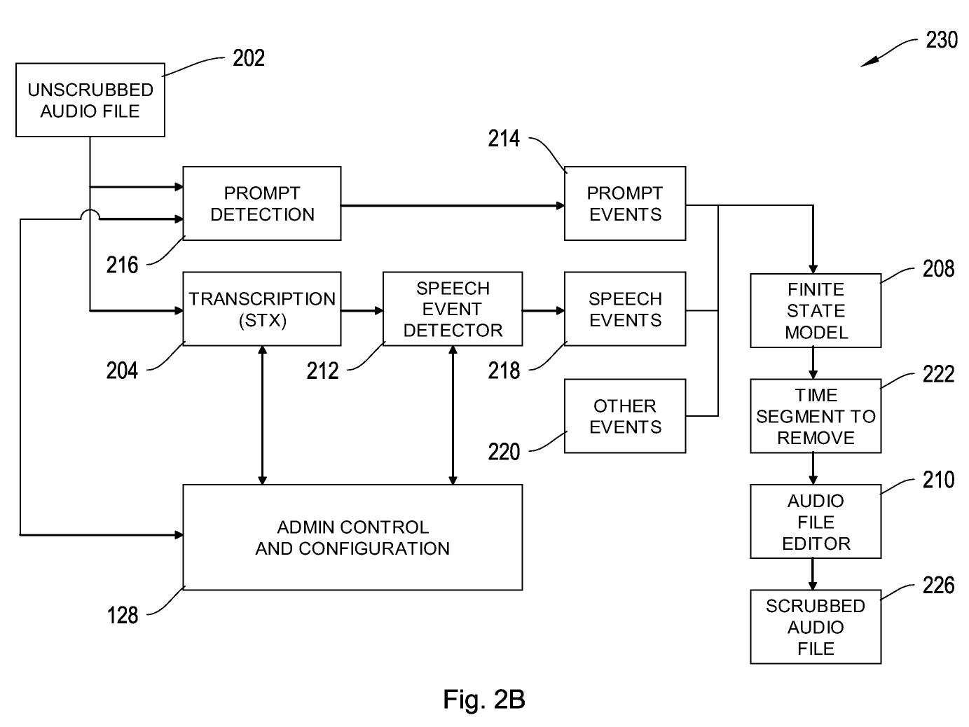

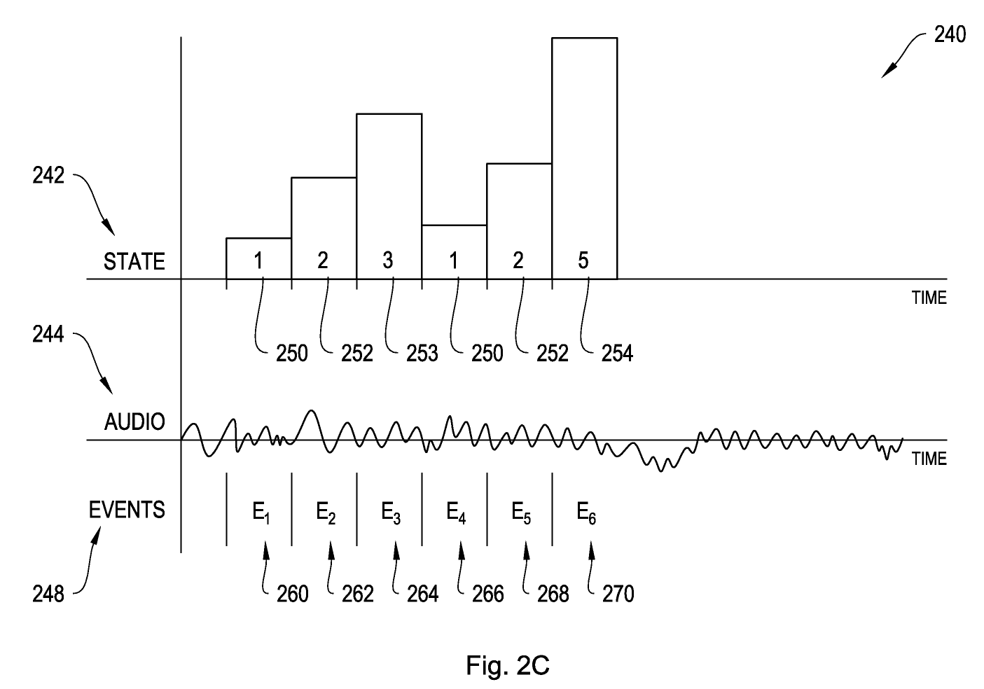

FIG. 2A is a conceptual block diagram of a call data processor depicted in the system architecture of FIG. 1.

FIG. 2B is a data flow diagram of a recording being processed by a system of FIG. 1.

FIG. 2C depicts pictorially a state machine responding to identified events in a recording.

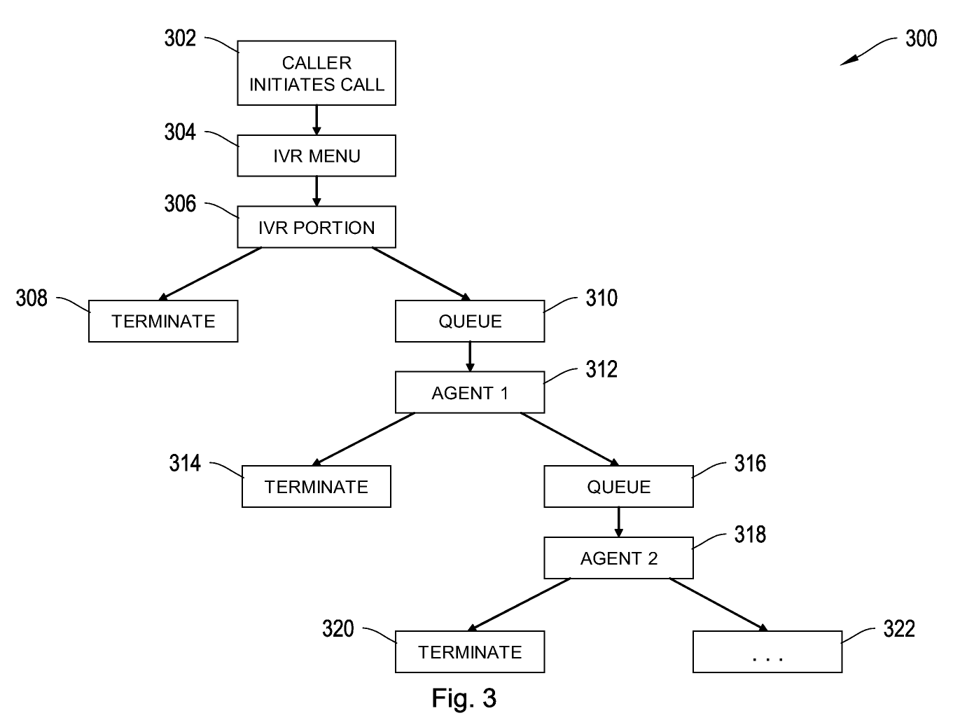

FIG. 3 depicts an illustrative flowchart of a typical recording of a call.

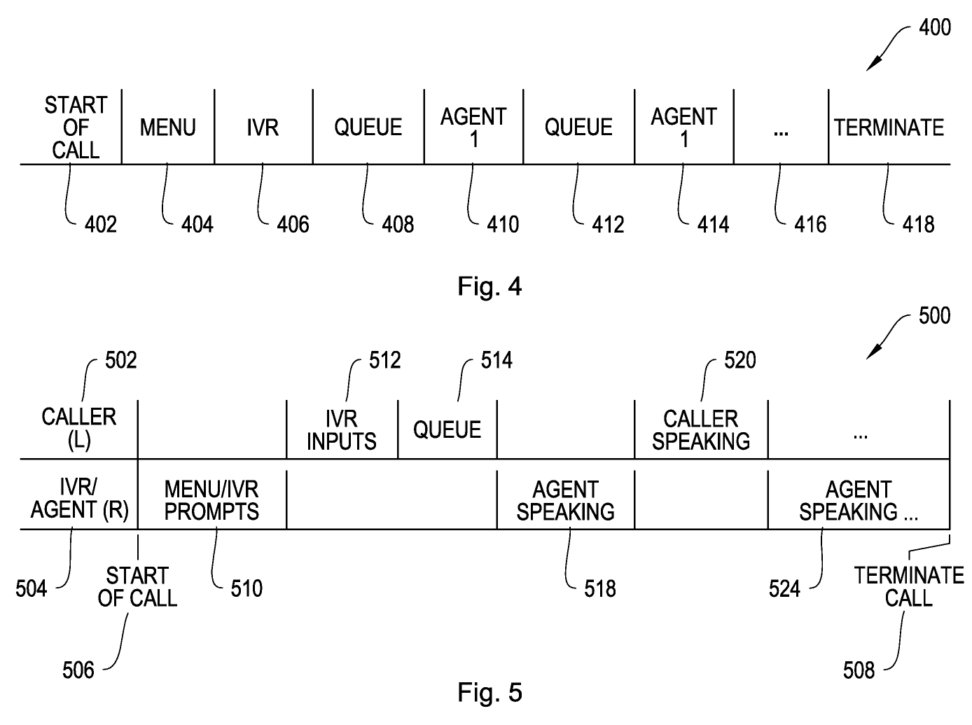

FIG. 4 depicts an illustrative timeline of a typical recording of a call according to the flowchart of FIG. 3.

FIG. 5 depicts an alternate example of an audio recording of a call according to the flowchart of FIG. 3 with separate channels for different participants of the call.

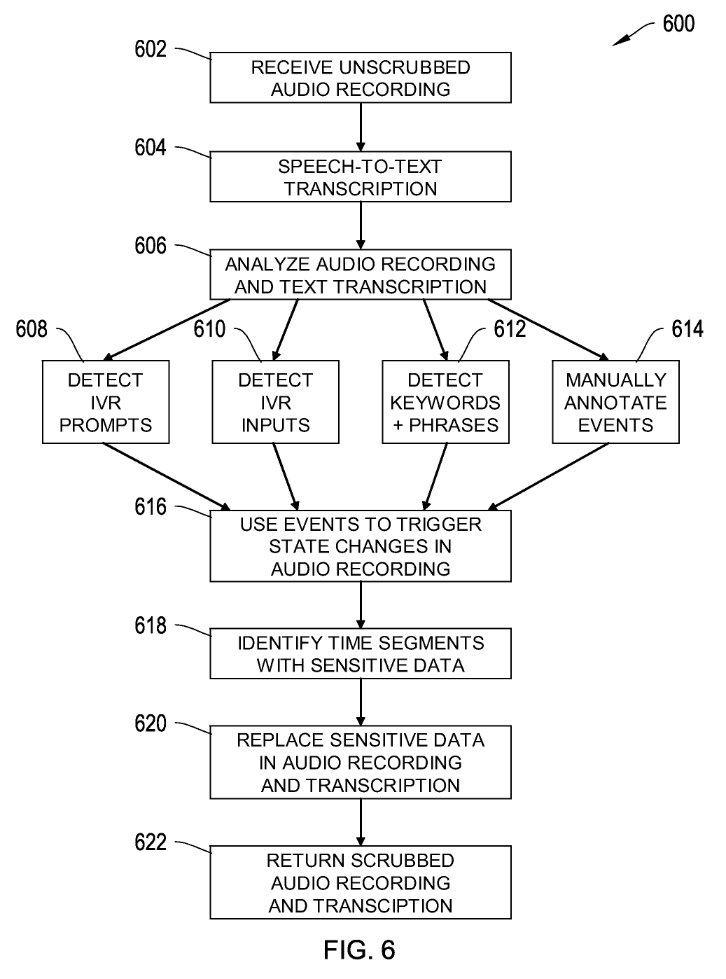

FIG. 6 is a flowchart of a process for removing sensitive information from an recording and text transcription of a call.

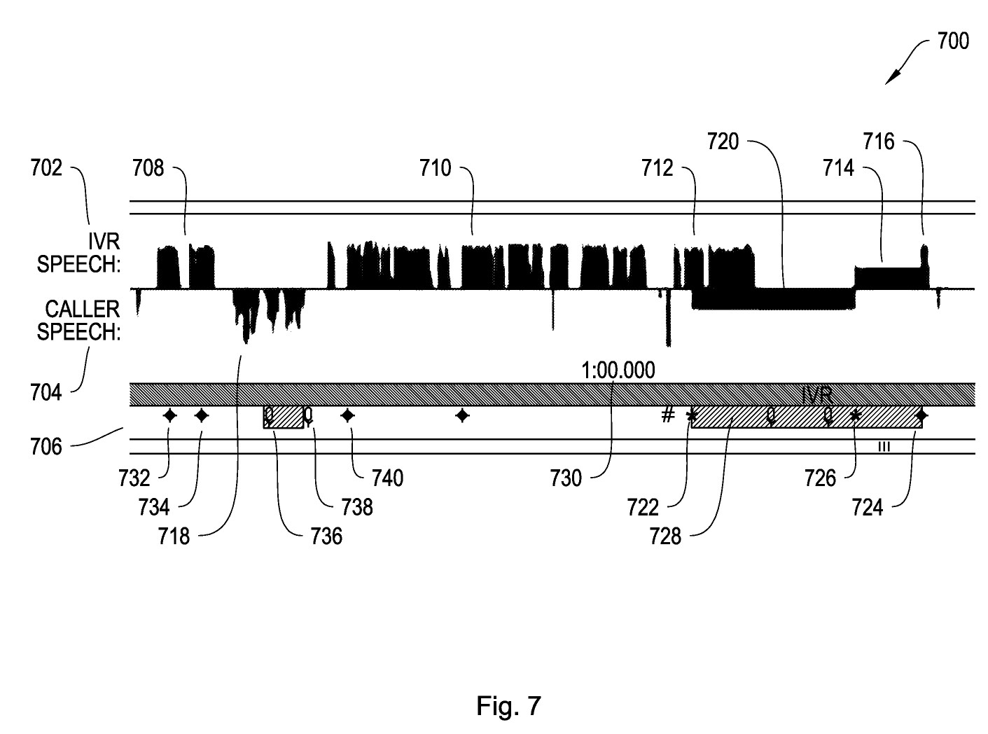

FIG. 7 depicts an illustrative example of an IVR-customer interaction including a graphical representation of the IVR and caller audio channels and redacted sensitive information.

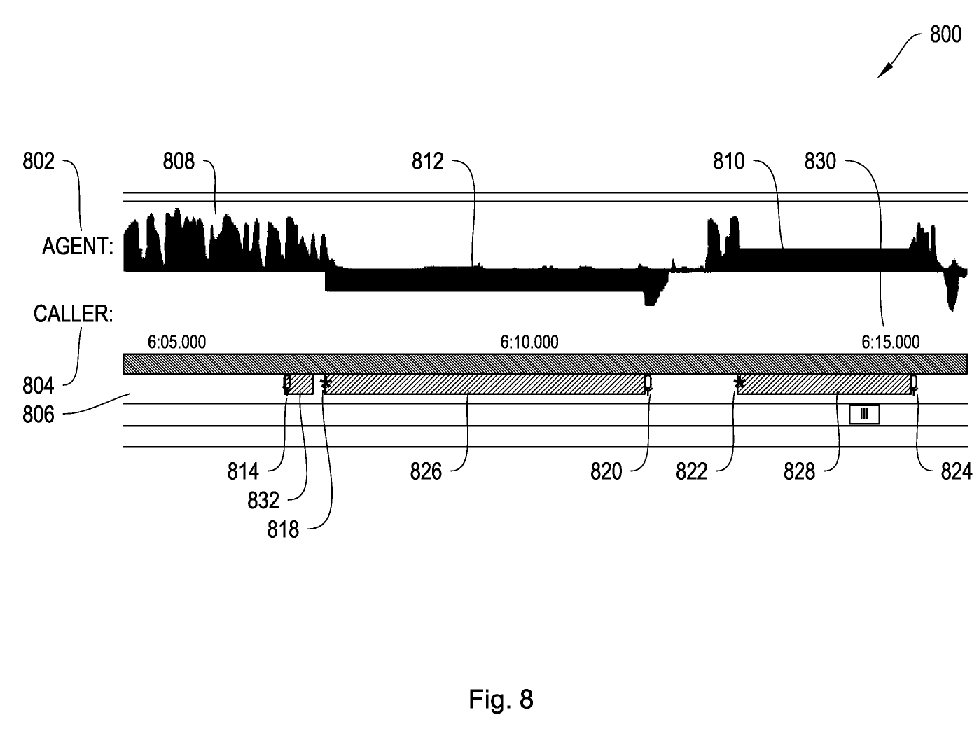

FIG. 8 depicts an illustrative example of an interaction between a customer and a call center agent, including a graphical representation of the agent and caller audio channels and redacted sensitive information.

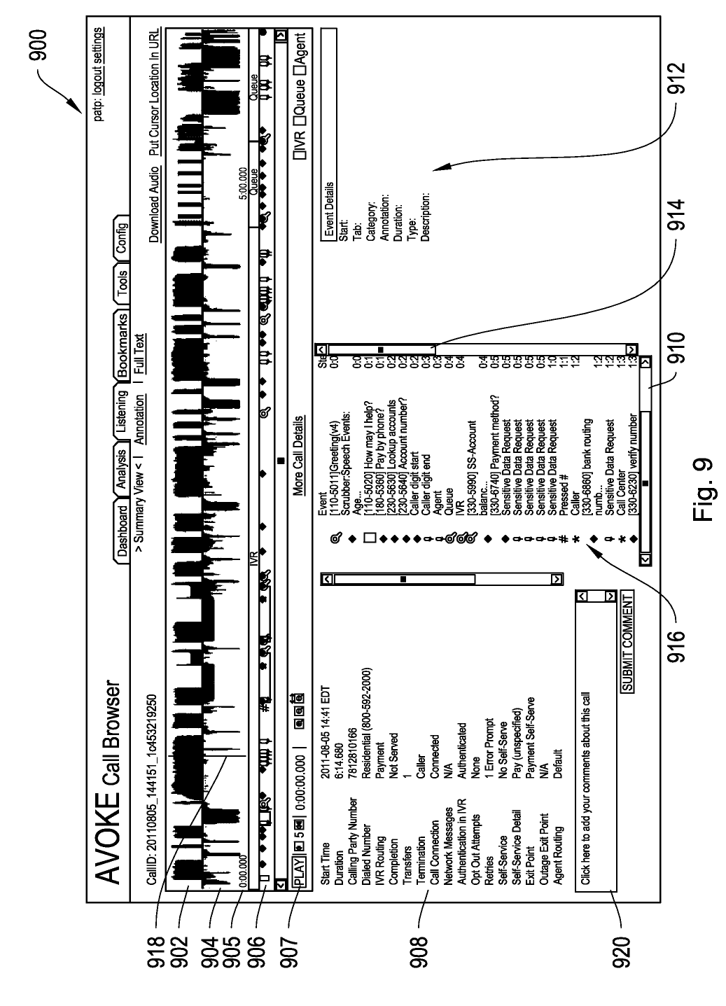

FIG. 9 depicts a typical user interface for presenting a redacted audio recording to a user, including a list of annotated events and call states which occurred during the call.

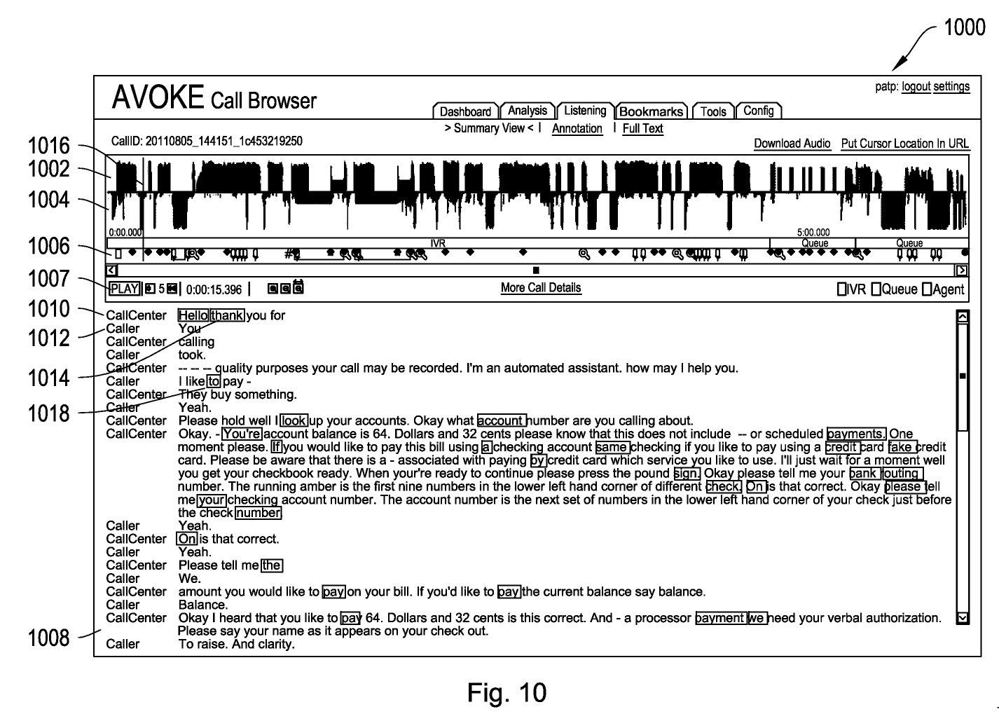

FIG. 10 depicts a typical user interface for presenting a redacted audio recording to a user, including a speech-to-text transcription of the call and highlighted keywords and phrases.

### DETAILED DESCRIPTION

To provide an overall understanding of the systems and methods herein, certain illustrative embodiments will now be described. For example, the systems and methods described below include systems and methods for removing sensitive data from an audio recording, such as a recorded telephone call. However, the systems and methods described herein have broad applicability and may be employed for any application that removes sensitive data from a recording by analyzing the recording to identify events occurring within a recording, or a sequence of events occurring within a recording, that indicate the presence and location of sensitive data within the body of the recording. Such systems and methods may remove sensitive data such as financial information, including access codes, personal identification numbers, patient medical data, military information, profanity and other sensitive data. The recording may be an audio recording, an audio/video recording, a video recording, or a combination of different types of recordings and different sources of recordings. As such, it will be understood by one of ordinary skill in the art that the systems and methods described herein can be adapted and modified for other suitable applications and that such other additions and modifications will not depart from the scope hereof.

In one particular example and embodiment, the systems and methods described herein provide systems for removing sensitive data from an audio recording of a call. These systems and methods receive end-to-end audio recordings of calls and analyze the recordings to detect events and actions that occur during the call. The events may represent characteristic audio patterns, such as an IVR prompt, a DTMF touch-tone input, a period of silence, a change in volume, or a change in speaker. The events may also represent certain keywords or phrases detected in a speech-to-text transcription of the call. The systems and methods use the detected events to determine a portion of the call that may contain sensitive data, such as a credit card number, credit card verification number, caller social security number, caller financial information, or other private information. Such sensitive information is removed from the audio recording, typically by replacing the portion of the call containing the sensitive information with nondescript audio, such as a flat tone, white noise, or silence. In this way, these example systems and methods provide an automated, configurable process for removing sensitive data from audio recordings of calls.

Turning to this example in more detail, FIG. 1 depicts an illustrative example system for removing sensitive information from a call recording in which some embodiments may operate. The system 100 includes a caller 102, a telephone network 104, a client call center 106, a call diagnostic center 120, and a web server 138. The call diagnostic center 120 may include a telephone network interface 122, a call recorder 124, a call data processor 126, an analyst station 128, a database controller 130, local storage memory 132, and internal network 134. The client call center 106 may include a call processor 108, a call center agent station 110, and local storage 112. The client call center 106 and call diagnostic center 120 may be connected by network 142 through optional firewall 136. Network 142 may also connect to a web server 138 with local storage 140.

In a typical situation, the caller 102 uses telephone equipment to call into the client call center 106 through telephone network 104. Telephone equipment can include traditional telephones connected through a land-line telephone network, mobile phones, voice over IP (VOIP) equipment, video conferencing devices, computer workstations, or any other suitable equipment for transferring voice and audio signals over telephone network 104. The client call center 106 may route the call to the call processor 108, which typically includes interactive voice response (IVR) equipment. The IVR equipment prompts the caller with predetermined options and allows the caller to input commands either through a keypad at their telephone equipment or through spoken voice commands which are analyzed by voice recognition software running on the IVR equipment. In some instances, the automated options and responses presented by the IVR equipment may be sufficient to address the caller's concern, and the call terminates before being routed to a live agent 110. In other instances, the IVR options may be used to gather more information about the caller's concern before routing to a live agent 110.

In some embodiments, a call diagnostic center 120 may be used to, among other things, analyze the performance and quality of service of the client call center. The call diagnostic center 120 may act as a silent third party between the caller 102 and client call center 106, such that a call gets routed first to the call diagnostic center 120, which passively “listens” to the call while concurrently routing the call to the client call center 106. Systems for connecting into calls to analyze the call are known in the art and include those systems described in U.S. Pat. No. 8,102,973, owned by the assignee hereof, the contents of which are incorporated by reference in their entirety. Any responses made by the IVR system or call center agent at client call center 106 may be routed first to the call diagnostic center 120 then to the caller 102, thus completing the circuit between caller 102 and client call center 106. The call diagnostic center 120 may record the call and analyze either the live call or a recording of the call to monitor certain performance metrics of the client call center 106 such as the average time of a call, the number of dropped calls during a day, the number of customers handled per agent, etc. In some embodiments, the call diagnostic center 120 receives only a small proportion of the total volume of calls handled by the client call center 106. The call diagnostic center 120 may be located external to any internal networks or firewalls that may be present in client call center 106. As such, the call diagnostic center 120 may be added to existing call center systems without requiring security access to the internal network of client call center 106, call processor 108, or call center local storage 112.

The call diagnostic center 120 includes a telephone network interface 122 that can be any suitable interface for hooking into or connecting into a telephone call. The interface 122 receives a call from caller 102 and forwards the call back to telephone network 104 to be switched through to client call center 106. As such, the network interface 122 may include any suitable equipment for coupling into the audio signals in telephone network 104 between the caller 102 and the client call center 106. In one embodiment, the network interface 122 may be a DirectTalk IVR platform programmed to dial into the call center and connect the caller's line to the line into the client call center 106. In some embodiments, the caller 102 may use a combination of telephone equipment and data equipment, such as a desktop workstation coupled to an IP network, and the network 104 may also carry data signals to the call diagnostic center 120 and client call center 106. In those embodiments, network interface 122 may also include a data logger (not shown) that receives copies of the data transmissions sent from the data equipment of caller 102 and the client call center 106. Techniques for rerouting, receiving, and sending copies of data packets over a network are well known in the art, and any suitable technique may be employed.

The call recorder 124 may receive audio signals from telephone network interface 122 and create a digital recording of the call. In one embodiment, the call recorder 124 is a conventional recorder of the type manufactured and sold by the Stancil Company of Santa Ana, Calif., but any suitable device for recording the call may be employed. This recorder 124 will create a digital representation of the audio waveform of the call, capturing the voice signals of caller 102 and any live agents from client call center 106. The call recorder 124 may also capture any audio prompts presented to the user by the IVR equipment of client call center 106 as well as any DTMF tones or spoken responses by caller 102. In this fashion, the call recorder 124 may record from the moment the call is initiated by the caller 102 until the caller 102 hangs up, creating an end-to-end call recording. In some embodiments, the call recorder 124 may limit capture to the audio waveform of a call, and typically that wave form includes the audio as well as other features that may be considered, such as volume changes, frequency ranges, power bands, transfer signals, or other features. In any case, the recorder 124 will record those characteristics of the call that may be later used to detect events of interest for identifying portions of the call containing sensitive information. For example, raised volume may indicate an event associated with screaming or arguing and this event may be used as part of a process to eliminate profanity or other sensitive data, from the recorded call. For the purposes of illustration and clarity, the systems and methods will now be described with reference to a system that records the audio waveform of a call from end-to-end, but such a discussion is provided merely as an example and is not to be deemed as limiting in any way.

Once the call has completed, the telephone network interface 122 may identify a signal indicating the end of the call and send an instruction to call recorder 124 to terminate the recording and mark the end of the call. The call recorder 124 may then provide the digital recording to various other components of the call diagnostic center 120 through internal network 134. The raw audio file, hereinafter referred to as an “unscrubbed” audio recording, may be sent to call data processor 126, which, as described in more detail below, may analyze the audio waveform, generate a speech-to-text transcription of the call, analyze the audio waveform and text transcription to identify the occurrence of events within the call, identify portions of the call containing sensitive information, and redact the sensitive information from audio recording and text transcription. Although the redaction process is described as being performed at call diagnostic center 120, it will be appreciated by one skilled in the art that the systems and methods described herein can perform the redaction process to remove sensitive information at other locations, and can for example, remove sensitive information from a recording at the client call center 106. Additionally and further optionally, removing the sensitive data from the recording may occur at some remote location by a third party working under an agreement, thus the removal of sensitive data may be outsourced to a service organization.

The call data processor 126 may be a process executing on a stack of Linux data processor or other conventional data processing systems, such as an IBM PC-compatible workstations running the Linux or Windows operating systems or a SUN workstation running a Unix operating system. Alternatively, the call data processor 126 may comprise a processing system that includes an embedded programmable data processing system, such as a single board computer (SBC) system. As such, the call data processor 126 may be any suitable computing system for analyzing an audio waveform for the occurrence of characteristic audio patterns and correlating such audio patterns with predetermined events. The process for generating audio waveforms to associate with an event, as well as correlation processes suitable for use with the call data processor 126 are known in the art and described, in, for example, U.S. Pat. No. 7,424,427 the contents being incorporated by reference.

The scrubbed audio recordings generated by call data processor 126 may be provided to database controller 130, which may store the recording as an audio file in local storage 132. In alternate embodiments, the scrubbed text transcriptions are also stored in local storage 132. The depicted database controller 130 and local storage 132 can be any suitable database system, including the commercially available Microsoft Access database, and can be a local or distributed database system.

The call data processor 126 and other components of call diagnostic center 120 may be configured by a user through a user interface at the analyst station 128. The station 128 may be any suitable computing device, such as a general purpose computer, that allows a human agent to interface with call data processor 126. The station 128 may allow a diagnostic center analyst to configure the redaction process performed by call data processor 126, for example by providing a list of IVR options, inputs, responses, keywords, phrases, or other detectable components within the recording. These components may be employed as features of an event. Thus, an event may be a larger pattern of recorded features, such as the detection of the phrase “classified information”, or “credit card number”, both of which may be features the system detects and identifies as an event or combines with other features, such as the recitation of a string of numbers, or the recitation of geographic location, to represent an event.

The call diagnostic center 120 may be optionally connected to client call center 106 through network 142. Network 142 may be any suitable network for transmitting data, including the Internet, a Local Area Network (LAN), a Wide Area Network (WAN), or the like. A firewall 136 may be included to restrict access to either the client call center 106 or call diagnostic center 120. A web server 138 with local memory 140 may also connect to network 142, providing an external storage location for scrubbed audio files and text transcriptions. It will be appreciated that other options, embodiments, and configurations may be implemented as would be obvious to one skilled in the art.

FIG. 2A is a block diagram of call data processor 126 depicted in the system 100 of FIG. 1. Call data processor 126 includes a speech-to-text transcriptor 204, event detector 206, finite state model 208, censor module 210, and communication device 212.

Call data processor 126 may receive a raw audio recording at input 202. These unscrubbed audio recordings may be received from call recorder 124, retrieved from local storage 132, or received from the client call center 106 through network 142. In some embodiments, the unscrubbed audio recording may be received in real-time as the call is taking place. The call data processor 126 includes a speech-to-text module 204 which creates a text transcription of the call using conventional speech-to-text software. In some embodiments, a text transcription may be received with the audio recording of the call. The text transcription and the audio recording may be passed to event detector 206, which identifies events of interest which occur during the call. The event detector 206 in this example is reviewing the audio recording of a call. The event detector 206 may identify characteristic audio patterns such as keypad inputs or voice commands into the IVR system as events or as components of events. The event detector 206 may further analyze the text transcription of the call to identify key words or phrases which indicate sensitive information. For example, the event detector 206 may identify the phrase “credit card” as an indication that the caller is about to speak or input their credit card number. It will be appreciated by one skilled in the art that the previous examples are for illustrative purposes only, and that any suitable method for identifying the occurrence of events in a recording, pod cast, audio-video recording or other recording may be used for the purposes of the systems and methods described herein.

The finite state model 208 may use the events detected by event detector 206 to determine portions of the call which contain sensitive information. In some embodiments, the finite state model 208 may identify a portion of a call as containing sensitive information. For example, the caller may select an IVR option to input his credit card information, enter his credit card number using a keypad, and subsequently input “#” to indicate that he is complete. Each of these inputs may be identified as an event by event detector 206, and the portion of the call between the initial IVR input and the “#” input may be identified by the finite state model 208 as containing sensitive information. In alternate embodiments, the finite state model 208 may identify a pre-determined amount of time after an identified event as containing sensitive information. For example, the caller may speak “credit card,” and the finite state model 208 may identify the subsequent 30 seconds of the call as containing sensitive information. In this manner, the finite state model identifies portions of the call which contain potentially sensitive information, with each portion associated with a start time and end time occurring within the call.

The censor module 210 may remove the identified portions of the call with sensitive information. In some embodiments, the censor module 210 may replace the audio between the start and end time with a different audio recording or pattern, such as a flat tone, white noise, or other nondescript audio. In embodiments where the recorded data also includes video data, the censor module 210 may optionally replace the video occurring between the start time and end time with a different video recording, such as a scrambled screen or a black screen. In this way, the processor 122 not only masks the sensitive information from playing upon future playbacks, but actually removes the actual bytes associated with the sensitive information from the file of the recording, thus preventing future unauthorized access to the sensitive information. The recording with redacted sensitive information, hereinafter referred to as a “scrubbed” file, may then be passed to communication device 212 for storage at local storage 132 or communication to client call center 106 through output 214.

FIG. 2B presents a data flow diagram illustrating the processing of an unscrubbed audio file 202 by a system such as the system 100 depicted in FIG. 1. In particular, FIG. 2B depicts an unscrubbed audio file 202 being presented to a prompt detection system 216 and a speech-to-text transcription block 204. As depicted in FIG. 2B the prompt detection system 216 can identify prompts event 214 that can be stored by the system 230 and subsequently applied to the finite state model 208. Additionally, the transcription speech-to-text system 204 can transcribe the unscrubbed audio file 202 to generate a text file representing the semantic content of the unscrubbed audio file 202. The text can be provided from system 204 to the speech event detector system 212. The speech event detector 212 can sort through the transcribed text to identify phrases or words that have been identified as speech events or features of speech events and from the features identified, the speech event detector 212 can identify the presence of speech events 218 within the transcribed text.

FIG. 2B further depicts that other events 220 can be identified and stored. The other event 220 may include a detected increase in volume within the unscrubbed audio 202 indicating a raised voice and possibly indicating a precursor to profane content, an audio tone that represents an attempt by a human sensor to scrub from the raw audio data sensitive information, or an indication of a change in language to indicate when an audio file 202 containing diplomatic content has been determined to include content in multiple languages, one language of which may be deemed to be associated with sensitive data. In any case, the system 230 processes the unscrubbed audio file 202 identify prompt events 214, speech events 218 and other events 220. The different events can be provided to the state model 208. The state model can be a state model that accepts events as input and responds to the events by changing states based on the input and current state of the model.

FIG. 2C presents a pictorial representation of the operation of the finite state model 208. In particular the FIG. 2C depicts a state transition graph 242 that shows a plurality of state transitions as the state model transitions between State 1 (250) to State 2 (252) to State 3 (253) and back to State 1 (250). Additionally FIG. 2C depicts the audio wave form 244 which represents the wave form of the unscrubbed audio file 202. The audio wave form 244 depicts the wave form as a function of time. Beneath the audio wave form 244 is an event sequence 248. As shown in FIG. 2C the depicted event sequence 248 includes a series of identified events that can represent prompt events such as the prompt events 214, speech events 218 or other events 220. These events can be provided to the state model 208 as inputs and will cause the event model as depicted in FIG. 2C to transition from State 1 (250) to State 2 (252) and so forth. In particular FIG. 2C shows that the state model 208 can start in State 1 (250). As the audio wave form proceeds, an event, Event 1 (260) is detected. Event 1 may be a prompt event representing the input of a certain prompt such as a keypad tone generated by striking the keypad of a telephone. Providing the Event 1 (260) to the state model 208 can drive the state model 208 from State 1 (250) into State 2 (252). As the audio wave form 244 progresses in time the prompt detection system 216 and speech event detector 212 can monitor the audio wave form 244 until a subsequent event in this case event E2 262 is detected. This event E2 262 is also provided to the state model 208 and drives the state model 208 from State 2 (252) into State 3 (253). In one example the Event E2 262 may represent that the speech event 218 has determined a string of numerals had been found within the wave form after a prompt which was found as Event E1 was earlier identified as a prompt associated with the command to enter a credit card number. As such, the Event E2 may represent the time segment of the audio wave form during which a user was entering a credit card number during which time that credit card number was recorded as part of the audio wave form 244. Consequently, the State 2 (252), delimited by State 1 (250) and State 3 (253) represents the time segment that stores within the audio wave form 244 the sensitive information that is to be removed.

Returning to FIG. 2B the finite state model 208 can pass the time segment to remove 222 to an audio file editor 210. The audio file editor 210 can be the sensor module 210 depicted in FIG. 2A and that sensor module can purge, as discussed earlier, from the audio wave form the sensitive information that represents the credit card information of the user. Once the time segment or time segments have been removed by the audio file editor 210 the scrubbed audio file 226 can be stored to memory, now with the sensitive information removed.

FIG. 3 depicts an illustrative flowchart 300 of a process as described herein which is applied to a recording that is a typical audio recording of a call. The steps of the flowchart include initiating the call at step 302, presenting the caller with an IVR menu at step 304, an interactive IVR portion at step 306, an optional termination at step 308, a queue portion at step 310, a first agent dialogue at step 312, an optional termination at step 314, a second queue portion at step 316, a second agent dialogue at step 318, and an optional termination at step 320. Further queue and agent dialogues can be repeated at step 322.

A typical audio recording begins with the caller initiating the call at step 302 and being route to an IVR system. After an automated welcome message, the IVR system may present the caller with an initial menu at step 304, which contains several predetermined choices for selection by the caller. Some choices may represent frequently asked questions or other common inquiries, and selection by the user may provide the desired information. For example, the caller may simply wish to know the store hours or inquire about the details of a particular product. In these cases, the answer provided by the IVR system may be completely sufficient to address the caller's reason for calling, and the call terminates at step 308.

In some embodiments, the call may progress to the IVR portion at step 306, which presents the caller with further prompts and allows them to make selections either through their telephone keypad or by speaking the option. The IVR portion may be used to gather more information about the caller before being transferred to a live agent. For example, the user may enter their credit card or billing information prior to speaking with a live agent, which saves the agent's time and prevents the agent from seeing or hearing sensitive information. Thus, the IVR system may query sensitive information from the caller which must later be redacted from the audio recording.

Once the information has been entered by the caller, or at any time upon the caller's request, the call may be transferred to a human agent for further handling. If a human agent is not immediately available, the caller will be placed “on hold” in the queue portion of the call at step 310. The queue portion may comprise a period of silence, music, advertisement, or any other predetermined recording that is presented to the caller while he or she waits. When ready, a human agent will answer the line and continue to address the caller's concern at step 312. If the agent is successful, the call will terminate at step 314.

If the first agent fails to sufficiently solve the caller's problem, the agent may transfer the caller to a second agent for further handling. For example, the first agent may only be qualified to handle general topics and may transfer the caller to a specialized department according to their needs. The caller may be placed back in the queue at step 316 to wait for a second agent dialogue at step 318. The call may then terminate at step 320, or continue the process of successive queue and agent dialogues at step 322.

FIG. 4 depicts an illustrative timeline 400 of a typical audio recording of a call according to the flowchart of FIG. 3. As discussed above, the call typically comprises a start signal 402, an IVR menu 404, an interactive IVR portion 404, one or more queue and agent dialogues 408-416, and a termination signal 418. These portions may be stacked by call recorder 124 in a single audio channel as shown in recording 400. In some embodiments, signals may be embedded into the recording which indicate a transition from one portion of the call to the next. These signals may be identified later in the event detection process to delineate the IVR, queue, and agent portions and establish rudimentary states for the call. In alternate embodiments, the event detection process may be able to automatically distinguish the different portions, for example, by identifying a particular transfer tone or queue music. Further, in other applications, the systems and methods described herein may be employed to remove sensitive information from a podcast, a recorded broadcast, a recorded activity, such as a surgical procedure, military operation or other activity. For these recordings the recording may include other portions, such as music portions, commercial portions, recordings from separate microphones and other similar portions. As such, these recordings may have timelines that may be segregated into other types of portions and the systems and methods described herein may employ these different segments to identify events.

FIG. 5 depicts an alternate example of an audio recording 500 according to the flowchart of FIG. 3 with separate audio channels for different participants of the call. The depicted recording has two channels, but recordings with three or more channels may also be processed. The depicted recording 500 includes a caller audio channel 502 and an IVR/Agent audio channel 504. Similar to the recording 400 depicted in FIG. 4, the recording 500 also includes a start signal 506, an IVR menu 510, interactive IVR portion 512, queue and agent dialogues 514-524, and a termination signal 508.

Recording 500 may be generated by call recorder 124 of the call diagnostic center 120 by distinguishing between the incoming audio from caller 102 and the outbound audio from client call center 106. In some embodiments, a stereo recording may be generated with the caller audio 502 on the left channel and the IVR/agent audio 504 on the right channel. As such, the IVR, queue, and dialogue portions of the call discussed in relation to FIG. 3 and FIG. 4 may be distributed between the two channels according to the source of the audio. In the IVR portion of the call, the IVR prompts 510, which are issued from the client call center 106, are recorded in the IVR/agent audio channel 504, while the caller's IVR inputs 512 are recorded in the caller audio channel 502. Thus, the caller audio channel 502 may comprise a series of caller responses to IVR prompts separated by periods of silence or background noise, allowing the event detector 206 to easily isolate and remove entire caller responses. For example, in response to the IVR prompt “Please enter your credit card number,” the call data processor 126 may simply remove the entire customer's response between two periods of silence in the caller audio channel instead of detecting individual credit card digits. This ability to remove entire caller responses may be especially important in the agent/caller dialogue portion of the call, where the prompts and responses can be relatively unpredictable.

Furthermore, separating the audio recording into different channels, such as the caller and agent channels 502 and 504 of the depicted example, may allow the call data processor 126 to analyze and redact the audio channels independently. Sensitive data may be removed only from the channel which contains the sensitive data, leaving the other channel intact. For example, an agent may say “credit card” in portion 518 of the call, and the caller may speak a series of digits in subsequent portion 520 in the caller channel 502. Portion 520 may be removed from the caller audio channel 502 by replacing the audio data with nondescript audio, while leaving the audio in the agent channel 504. Thus, the agent prompts and intermediate responses are left in the agent audio channel 504, preserving the general context of the call.

FIG. 6 depicts a flowchart 600 for removing sensitive information from an audio recording of a call. The method 600 includes receiving an unscrubbed audio recording at step 602, performing a speech-to-text transcription at step 604, analyzing the audio recording and text transcription for the occurrence of events at step 606, which includes detecting IVR prompts at step 608, detecting IVR inputs at step 610, detecting keywords and phrases at step 612, and receiving manually annotated events at step 614, using the events to trigger state changes in the audio recording at step 616, identifying time segments with sensitive data at step 618, replacing the sensitive data in the audio recording and text transcription at step 620, and returning the scrubbed audio recording and transcription at step 622.

At step 202, the call data processor 126 receives an unscrubbed audio file. The unscrubbed audio file typically represents a raw recording of a call which requires editing to remove sensitive information before the audio file is stored, typically permanently. In some embodiments, the received unscrubbed audio file may be a complete end-to-end recording of a call retrieved, for example, from local storage 132. In alternate embodiments, the unscrubbed audio file may be streamed in real-time from the telephone network 104 and network interface 122 while the call is taking place.

At step 604, the speech-to-text module 204 performs a speech-to-text transcription of the call. In some embodiments, a text transcription may already be available and received with the unscrubbed audio file. This may be the case, for example, if a call center has previously transcribed the audio file as a part of a separate analysis. The speech-to-text module 604 may use any suitable speech recognition software for translating spoken words in the audio recording into text. In the case where multiple languages are spoken in the audio recording, the speech-to-text module 604 may also provide a multilingual text transcription by using a single speech recognition program which includes all the languages or by automatically switching between multiple programs which cover all the languages spoken in the recording. The speech-to-text module 604 may also transcribe the automated IVR prompts as spoken by the IVR system and any IVR inputs from the user, including DTMF tones. The transcription may include timestamp information for associating the text with a corresponding portion of the audio waveform. In some embodiments, each word may include a timestamp such that the exact timing for each spoken word in the audio waveform is known. In other embodiments, the timestamps may be associated with specific events which occur during the call or with certain detected keywords and phrases as described further below.

The audio recording and text transcription are passed to event detector 206 and analyzed at step 606 for the occurrence of events. These events may include characteristic audio patterns that occur during the call, such as IVR prompts, DTMF inputs by the user, a period of silence, a change in volume, a change in speaker, music, or other identifiable audio patterns. At step 608, the event detector 206 may detect IVR prompts which have been presented to the user. These prompts may comprise an automated recording which presents the user with a series of options. Since the prompts are pre-programmed into the IVR system prior to the call, the prompts which ask for sensitive information from the caller may be identified. For example, out of five options presented to the caller, two of the options may be known as pertaining to purchasing/billing and ask for the caller's payment information. Any suitable technique for identifying IVR prompts which ask for sensitive information may also be used. Similarly, the event detector 206 may detect caller inputs into the IVR system at 610, and inputs containing sensitive information may be easily identified based on knowledge of the IVR options and the caller's inputs. In the agent/caller dialogue portion, the event detector 206 may identify a change in speaker or a period of silence to distinguish between agent prompts and caller responses.

The event detector 206 may also analyze the text transcription of the call at step 612 for the occurrence of certain keywords and phrases which indicate sensitive information. For example, the phrase “credit card” occurring in the text transcription may indicate a credit card number about to be entered by the caller. A predetermined list of keywords, phrases or patterns of interest may be compared to the text transcription to detect text which comprises or immediately precedes sensitive information. In some embodiments, text that immediately precedes sensitive information may comprise keywords or phrases which indicate that the next word or phrase contains sensitive information. In other embodiments, a predetermined number of words or time window following the keyword or phrase may be searched for sensitive information, such as a spoken series of digits.

The event detector 206 may assign a timestamp to the each of the detected events for later use in determining which portions of the call contain sensitive information. Furthermore, the event detection process may be fully customized by a call diagnostics analyst. For example, an analyst may maintain a database of stored audio patterns representative of typical events which occur before or after sensitive information in an audio recording. Similarly, a list of keywords, patterns or phrases may be predetermined by the analyst and compared against the text transcription. The analyst may also manually indicate events which occur during the call, either by annotating directly on the audio waveform or by highlighting keywords or phrases in the text transcription.

In step 616, the events as detected above are passed to the finite state model 208, which uses the events to divide the call into portions and to trigger state transitions between the portions. In general, a call state can be any information which describes the context of the call portion, such as whether the caller is in the IVR, queue, or agent dialogue portion of the call, the path that the caller took through the IVR, the final state in the IVR system prior to transfer to the agent, or any other property associated with the call portion. For the purposes of removing sensitive information, the finite state model 208 may define states indicating whether a portion of the call contains sensitive information, immediately precedes sensitive information, possibly contains sensitive information, or does not contain sensitive information.

At step 618, the finite state model 208 identifies portions of the call which contain sensitive information. In some embodiments, identifying portions of the call containing sensitive information comprises identifying an event which immediately precedes sensitive information and identifying an event which immediately follows sensitive information. In some embodiments, an event which immediately precedes information may comprise an event detected in one channel which indicates that subsequent audio in the other channel contains sensitive information and should be redacted. As an illustrative example, a caller may respond to an IVR prompt requesting credit card information. The caller may then enter their credit card number and press “#” on their telephone keypad to indicate that they are finished. The portion of the call between the initial IVR prompt and the “#” would be identified as containing sensitive information, i.e., the caller's credit card number. In alternative embodiments, the finite state model 208 may set a predetermined amount of time after an initial event as containing sensitive information. In the above example, 30 seconds after the initial IVR prompt may be identified as containing sensitive information. In this manner, the finite state model 208 identifies portions of the call containing sensitive information based on the detected events, with each portion of the call having a corresponding start time and end time.

The call censor module 210 redacts the sensitive data from both the audio recording and the text transcription at step 620. Redacting the audio recording may comprise overwriting the data in the audio file between the start and end time of a portion with a flat tone, white noise, silence, or other nondescript audio. Similarly, redacting the text transcription may comprise overwriting the data in the text transcription associated with the portion with nondescript text such as dashes, blanks, or asterisks. The sensitive text may also simply be deleted from the text transcription altogether. Thus, the sensitive information is completely removed from both the audio waveform and the text transcription of the call and cannot be subsequently recovered. The scrubbed audio file and text transcription are returned for storage at step 622, for example, at local storage 132.

FIG. 7 depicts an illustrative example of an IVR-customer interaction including a graphical representation of the IVR and caller audio channels and redacted sensitive information. The graphical interface 700 includes IVR channel 702, caller channel 704, and annotated events window 706. The IVR channel 702 includes IVR portions 708-716. The caller channel 704 includes caller portions 718 and 720. The events window 706 includes annotated events 722-726 and 732-740, highlighted portion 728, and timeline 730.

The IVR channel 702 and caller channel 704 include graphical representations of the audio waveform of the call. The IVR and the caller are recorded on separate audio channels so that redaction can take place on each channel independently. The IVR system prompts the caller in portion 708, and the caller responds in portion 718. During this portion of the call, various events are detected, represented by differently shaped icons in events window 706. The IVR prompts are denoted by icons 732 and 734, and certain keywords detected in the caller's response are denoted by icons 736 and 738. As discussed above, these icons may represent automatically identified audio patterns, keywords, phrases, or manually annotated events by an analyst. The response contains no sensitive information, so the portion 718 is not redacted.

Continuing with the example, the IVR system provides some information to the user in portion 710 and prompts the caller for a credit card number in portion 712. The caller's response 720, which starts at event 722, contains sensitive information, and is thus redacted from the call. In this example, the caller's response is replaced with a flat tone, represented by a constant line in the audio waveform of 720. Furthermore, even though the caller's response 720 overlaps with IVR prompt 712, the IVR channel is not redacted during this portion of the call, thus prompt 712 is left in the recording. In the events window 706, the sensitive information is indicated by the shaded portion 728, which begins with event 722 and ends with event 724.

At event 726, the IVR system repeats the credit card number back to the caller, and this audio 714 is also redacted from the IVR channel 702. The exact length of the IVR response 724 may be well known through prior knowledge of the IVR system, so the call censor module 210 may redact the exact amount of time for the IVR response 714 and return the audio at point 716.

FIG. 8 depicts an illustrative example of an interaction between a customer and a call center agent, including a graphical representation of the agent and caller audio channels and redacted sensitive information. The graphical interface 800 includes agent channel 802, caller channel 804, and events window 806. Agent channel 802 includes agent portions 808 and 810, and caller channel 804 includes caller portion 812. Events window 806 includes events 814-824, highlighted portions of the call 826, 828, and 832, and timeline 830.

Similar to the graphical interface 700 depicted in FIG. 7, the graphical interface 800 includes graphical representations of the audio waveforms for both the agent channel 802 and the caller channel 804. In portion 808, the agent asks the caller to enter an account number, and the caller responds with a series of digits in portion 812. The event detector 206 may detect the words “account number” spoken by the agent in a text transcription of the call (not shown) associated with portion 808, generating the event 814. Event 814 may be used by the finite state model 208 to determine that sensitive information is about to occur in the call, shown by highlighted portion 832. The event detector 206 may also detect the series of digits spoken in caller portion 812 and generate the event 818 which starts the portion of the call containing sensitive information. Event 820 may be generated after a specific number of digits has been spoken, after a predetermined amount of time, manually generated by a human analyst, or in response to a period of silence or other audio pattern indicating that the caller has finished his or her response. Between event 818 and 820, the finite state model 208 may mark the portion of the call as containing sensitive information, indicated by the highlighted portion 826. The call censor module 210 then replaces the audio data between event 818 and 820 with a flat tone, redacting the sensitive information from the recording.

In portion 810, the agent repeats the account number back to the caller, which may be redacted in a similar manner as portion 812. Event 822 is generated when the agent begins speaking a series of digits, as detected in the text transcription of the call. Event 824, which ends the portion with sensitive information, which may be generated after a specific number of digits has been spoken, after a predetermined amount of time, manually generated by a human analyst, or in response to a period of silence or other audio pattern indicating the end of the agent's remark. These events 822 and 824 are passed to the finite state model 208, which marks the portion of the call between the events as containing sensitive information, shown by highlighted portion 828. The call censor module 210 removes the portion of the call between the events by replacing the audio with a flat tone.

FIG. 9 depicts a typical user interface for presenting a redacted audio recording to a user, including a list of annotated events and call states which occurred during the call. The interface 900 includes an agent audio channel 902, a caller audio channel 904, waveform indicator 918, an annotated events window 906, playback controls 907, call properties window 908, call comment box 920, event list 910, and event details window 912. The event list 910 also includes event icons 916 and event indicator 914.

The agent audio channel 902 and caller audio channel 904 include a complete audio waveform of an end-to-end call recording, including the IVR portion, queue, and one or more agent conversations. As discussed above, the recording may provide separate audio channels for the caller and agent as shown, or may be a combined single audio channel. Below the waveform is the annotated events window 906, which displays the different events that were detected within the call. Different icons are used for different types of events, such as IVR menu prompts, IVR inputs, keywords, phrases, periods of silence, transfer signals, change in volume, change in speaker, or manual annotations, among others. Each event is associated with a timestamp and displayed along the timeline 905. The annotated event window 906 may also shade between certain events to indicate call states, such as portions of the call which contain sensitive information.

The playback controls 907 may allow a user to play the audio waveform and hear what actually occurred between the caller and the IVR/agent. The playback controls 907 may allow the user to, among other things, play, fast forward, rewind, skip forward/backwards, play in slow motion, or perform other typical playback functions as is know in the art. Waveform indicator 918 may move along with the playback and allow the user to select a particular time on the waveform to control where playback begins. The user may also “click and drag” the waveform indicator 918 to highlight a portion of the call and playback only the highlighted portion. The user may also use the playback controls 907 to zoom in on the highlighted portion. This may be especially useful to analyze segments of the call with a high density of detected events as shown in the annotated events window 906.

The call properties window 908 may provide the user with basic information about the call, including the start time, duration, calling number, options chosen in the IVR system, and number of transfers. The user may enter additional comments in call comment box 920. The event list 910 contains a list of the detected events in the call and their corresponding timestamps. The event list 910 may also include the icon 916 used for display in the annotated events list 906. The event indicator 914 may allow a user to select an event from the list and provide another mechanism for navigating within the audio waveform. The event indicator 914 and the waveform indicator 918 may move synchronously such that selecting an event from event list 910 may automatically move waveform indicator to the corresponding time in the waveform. This may additionally result in playback of an associated portion of the waveform, allowing the user to hear the portion of the call that generated the event. Similarly, moving the waveform indicator 918 may automatically move the event indicator 914 to the closest detected event.

The details of a selected event, including start time, type, and duration, may be displayed in event details window 912. The event details window 912 may also allow the user to manually input new events for display in the annotated events window 906 and events list 910. The user may input certain required information such as start time and duration and optionally include other information such as the type of event, summary of the event, description/annotation, etc. For example, the user may identify a portion of the call that contains unexpected sensitive data and define manual events at the start and stop time of the identified portion that the call data processor 126 may use to redact the data.

FIG. 10 depicts a typical user interface for presenting a redacted audio recording to a user, including a speech-to-text transcription of the call and highlighted keywords and phrases. The user interface 1000 of FIG. 10 includes similar elements as the user interface 9000 of FIG. 9, including an agent and caller audio channels 1002 and 1004, a waveform indicator 1016, an annotated events window 1006, and playback controls 1007. User interface 1000 further includes a text transcription 1008, which comprises call center agent dialogue 1010, caller dialogue 1012, highlighted keywords and phrases 1014, and text indicator 1018.

The text transcription 1008 may be displayed concurrently, separately, or in combination with any of the call properties window 908, events list 910, or event details window 912 depicted in FIG. 9. As described above, the text transcription 1008 may comprise a speech-to-text transcription of the audio recording and include separate lines for call center agent speech 1010 and caller speech 1012. The text transcription 1008 may also highlight the keywords or phrases of interest 1014 as detected by event detector 206. Text indicator 1018 may allow the user to select certain words and provide another mechanism for navigating within the call. Text indicator 1018 may move synchronously with waveform indicator 1016 and/or event indicator 914 as described in relation to FIG. 9. In particular, each word may be associated with a timestamp such that selection of the word with text indicator 1018 may move the waveform indicator 1016 to the corresponding time in the waveform.

Some embodiments of the above described may be conveniently implemented using a conventional general purpose digital computer or server that has been programmed to carry out the methods described herein. In such cases, the systems and methods described herein may program the computer, computers, server, servers or other data processing equipment to, among other things, receive a recording, whether audio, video or both. The system identifies within the recording events that are characteristic patterns, typically audio patterns but they may be video patterns or a combination of audio and video patterns. To identify the events, the system may compare patterns found in the recording with patterns stored in a database of known patterns. The system may then select from the identified events a location within the recording that includes, or is likely to include, sensitive data. In one embodiment, the system identifies the location of the sensitive data by applying a finite state machine that receives the identified events as inputs, which are applied to the state machine in the order the events appear within the recording. The finite state machine may transition through states, driven by the sequence of events, and may be driven into a state that indicates the presence, and the location, within the recording of sensitive data. From this state, the system identifies a time segment within the recording to process and thereby may remove the sensitive data from the recording. Those of skill in the art would understand that information and signals may be represented using any of a variety of different technologies and techniques. For example, data, instructions, requests, information, signals, bits, symbols, and chips that may be referenced throughout the above description may be represented by voltages, currents, electromagnetic waves, magnetic fields or particles, optical fields or particles, or any combination thereof.

Some embodiments include a computer program product comprising a computer readable medium having instructions stored thereon/in and, when executed, e.g., by a processor, perform methods, techniques, or embodiments described herein, the computer readable medium comprising sets of instructions for performing various steps of the methods, techniques, or embodiments described herein. The computer readable medium may comprise a storage medium having instructions stored thereon/in which may be used to control, or cause, a computer to perform any of the processes of an embodiment. The storage medium may include, without limitation, any type of disk including floppy disks, mini disks, optical disks, DVDs, CD-ROMs, micro-drives, and magneto-optical disks, ROMs, RAMs, EPROMs, EEPROMs, DRAMs, VRAMs, flash memory devices including flash cards, magnetic or optical cards, nanosystems including molecular memory ICs, RAID devices, remote data storage/archive/warehousing, or any other type of media or device suitable for storing instructions and/or data thereon/in.

Stored on any one of the computer readable medium, some embodiments include software instructions for controlling both the hardware of the general purpose or specialized computer or microprocessor, and for enabling the computer or microprocessor to interact with a human user and/or other mechanism using the results of an embodiment. Such software may include without limitation device drivers, operating systems, and user applications. Ultimately, such computer readable media further includes software instructions for performing embodiments described herein. Included in the programming software of the general-purpose/specialized computer or microprocessor are software modules for implementing some embodiments.

The method can be realized as a software component operating on a conventional data processing system such as a Unix workstation. In that embodiment, the synchronization method can be implemented as a C language computer program, or a computer program written in any high level language including C++, Fortran, Java or BASIC. See The C++ Programming Language, 2nd Ed., Stroustrup Addision-Wesley. Additionally, in an embodiment where microcontrollers or DSPs are employed, the synchronization method can be realized as a computer program written in microcode or written in a high level language and compiled down to microcode that can be executed on the platform employed.

It will be apparent to those skilled in the art that such embodiments are provided by way of example only. It should be understood that numerous variations, alternatives, changes, and substitutions may be employed by those skilled in the art in practicing the invention. Accordingly, it will be understood that the invention is not to be limited to the embodiments disclosed herein, but is to be understood from the following claims, which are to be interpreted as broadly as allowed under the law.

What is claimed is:

1. A method for removing sensitive data from a recording comprising:
receiving a recording of data recorded over a timeline,
identifying events representative of characteristic audio patterns which occur within the recording by comparing the recording to a database of known audio patterns,
inputting the identified events into a finite state machine in an order based on a sequential order of the events within the recording, the finite state machine having a state indicating a presence of sensitive data,
determining a portion of the recording containing sensitive data by correlating the state indicating sensitive data, and the timeline of the recording wherein the portion of the recording has a start time and end time, and
removing the portion of the recording between the start time and end time.

2. The method of claim 1 wherein the recording is an audio recording and further comprising receiving a text transcription of the recording and identifying events representative of speech by comparing the text transcription to a list of keywords, phrases and patterns.

3. The method of claim 2 further comprising removing text from the text transcription which is associated with the identical portion of the recording.

4. The method of claim 1 wherein the recording includes pod casts, recorded broadcasts, recorded presentations, recorded telephone calls, and recorded radio communications.

5. The method of claim 1, wherein removing the portion of the recording comprises replacing the portion of the recording with the finite state indicating sensitive data, with a predetermined audio pattern.

6. The method of claim 5, wherein the predetermined audio pattern includes a flat tone, white noise, or a period of silence.

7. The method of claim 1, wherein the recording includes at least two separate audio channels for each participant of the call.

8. The method of claim 7, wherein the recording is an audio recording of a call and the portion of the call containing sensitive data occurs on one of the two separate audio channels.

9. The method of claim 8, wherein the first event occurs on one of the two separate audio channels and precedes sensitive information which occurs on the other audio channel.

10. The method of claim 8, wherein removing the portion of the call comprises removing the portion of the call from one of the two separate audio channels.

11. The method of claim 1, wherein the characteristic audio patterns include an audio prompt of an interactive voice response system.

12. The method of claim 1, wherein the characteristic audio patterns include a caller input into an interactive voice response system.

13. The method of claim 1, further comprising allowing an administrator to manually identify an event which occurs during the call.

14. The method of claim 1 wherein sensitive data includes a credit card number, credit card verification number, caller social security number, caller financial information, or caller private information.

15. The method of claim 1 wherein the audio recording is an end-to-end recording of a call and includes at least an interactive voice response (IVR) portion and a spoken conversation portion between two or more human participants.

16. A system for removing sensitive data from a recording, comprising:
a communication device for receiving a recording recorded over a timeline,
a processor for identifying events representative of characteristic audio patterns which occur within the recording by comparing the audio recording to a database of known audio patterns,
a finite state machine, responsive to a sequential input of the identified events, to identify a sequence of identified events indicating a presence of sensitive data, and
a process for determining a portion of the recording containing sensitive data by correlating the state indicating sensitive data, and the timeline of the recording wherein the portion of the recording has a start time and end time and for removing the portion of the recording having sensitive information.

17. The system of claim 16 wherein the communication device further receives a text transcription of the recording and wherein the processor is further configured to identify events representative of speech by comparing the text transcription to a predetermined list of keywords and phrases.

18. The system of claim 17 wherein the processor is further configured to remove text from the text transcription which is associated with the portion of the recording between the start and end time.

19. The system of claim 16, wherein removing the portion of the recording comprises replacing the portion between the start and end time with a predetermined audio pattern.

20. The system of claim 19, wherein the predetermined audio pattern includes a flat tone, white noise, or a period of silence.

21. The system of claim 16, wherein the recording includes an audio recording of a call having at least two separate audio channels for each participant of the call.

22. The system of claim 21, wherein the portion of the call containing sensitive data occurs on one of the at least two separate audio channels.

23. The system of claim 22, wherein the first event occurs on one of the separate audio channels and precedes sensitive information which occurs on the other audio channel.

24. The system of claim 22, wherein removing the portion of the call comprises removing the portion of the call from one of the audio channels.

25. The system of claim 16, wherein the characteristic audio patterns include an audio prompt of an interactive voice response system.

26. The system of claim 16, wherein the characteristic audio patterns include a user input into an interactive voice response system.

27. The system of claim 16, further comprising a user interface configured to allow a user to manually identify an event which occurs during the call.

28. The system of claim 16 wherein the sensitive data includes a credit card number, credit card verification number, caller social security number, caller financial information, or caller private information.

29. The system of claim 16 wherein the recording includes an end-to-end recording of a call and includes at least an interactive voice response (IVR) portion and a spoken conversation portion between two or more human participants.
